(19) United States
(12) Patent Application Publication
(10) Pub. No.: US 2026/0261288 A1
(43) Pub. Date: Sep. 3, 2026

(54) RECONFIGURABLE INTELLIGENT SURFACE COEFFICIENT TIME DOMAIN ROTATION

(71) Applicant: QUALCOMM Incorporated, San Diego, CA (US)

(72) Inventors: Min HUANG, Beijing (CN); Jing DAI, Beijing (CN); Hao XU, Beijing (CN)

(21) Appl. No.: 19/164,957

(22) PCT Filed: Apr. 25, 2023
(86) PCT No.: PCT/CN2023/090515

§ 371 Date: Sep. 12, 2025

(51) Int. Cl. H04B 7/04; H04W 24/10; H04W 72/0446

(52) U.S. Cl. CPC H04B 7/04013; H04W 24/10; H04W 72/0446

(57) ABSTRACT

Certain aspects of the present disclosure provide a method for wireless communications at a network entity, generally including transmitting signaling configuring at least one reconfigurable intelligent surface (RIS) with a time-domain rotation factor to apply time variant reflection coefficient rotation, wherein the time-domain rotation factor is based on a Doppler frequency corresponding to a reflection link between the network entity and a user equipment (UE) via the at least one RIS and communicating with the UE, via the RIS, after transmitting the signaling.

### BACKGROUND

### Field of the Disclosure

Aspects of the present disclosure relate to wireless communications, and more particularly, to techniques for configuring reconfigurable intelligent surface (RIS) elements.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communications at a network entity. The method includes transmitting signaling configuring at least one reconfigurable intelligent surface (RIS) with a time-domain rotation factor to apply time variant reflection coefficient rotation, wherein the time-domain rotation factor is based on a Doppler frequency corresponding to a reflection link between the network entity and a user equipment (UE) via the at least one RIS; and communicating with the UE, via the RIS, after transmitting the signaling.

Another aspect provides a method for wireless communications at a reconfigurable intelligent surface (RIS) controller. The method includes receiving signaling, from a network entity, indicating a time-domain rotation factor; and varying reflection coefficients of one or more elements of at least one RIS by applying a time variant reflection coefficient rotation, based on the time-domain rotation factor.

Another aspect provides a method for wireless communications at a user equipment (UE). The method includes receiving, from a network entity, signaling indicating a time-domain rotation period that determines how often coefficients of reconfigurable intelligent surface (RIS) elements of at least one RIS are updated; and updating Doppler processing performed at the UE, based on the time-domain rotation period.

Other aspects provide: an apparatus operable, configured, or otherwise adapted to perform any one or more of the aforementioned methods and/or those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment.

FIGS. 4A, 4B, 4C, and 4D depict various example aspects of data structures for a wireless communications network.

FIG. 5 depicts an example wireless communication network impeded by a blockage.

FIG. 6 depicts an example wireless communication network having an array of reconfigurable intelligent surface (RIS) elements.

FIGS. 7A and 7B depict example RIS deployments.

FIGS. 8A and 8B depict example use cases for RIS deployments.

FIG. 9 depicts an example virtual RIS deployment.

FIG. 10 depicts a call flow diagram for communications in a network between a network entity and a RIS controller, according to certain aspects of the present disclosure.

FIG. 11 depicts a call flow diagram for configuring RIS arrays with time domain rotation factors, according to certain aspects of the present disclosure.

FIG. 12 depicts a call flow diagram for determining RIS time domain rotation factors, according to certain aspects of the present disclosure.

FIG. 13 depicts a timing diagram for applying RIS time domain rotation factors, according to certain aspects of the present disclosure.

FIG. 14 depicts a timing diagram for applying RIS time domain rotation factors, according to certain aspects of the present disclosure.

FIGS. 15A and 15B depict examples of potential performance improvements achievable using RIS time domain rotation factors, according to certain aspects of the present disclosure.

FIGS. 16A and 16B depict examples of potential performance improvements achievable using RIS time domain rotation factors, according to certain aspects of the present disclosure.

FIG. 17 depicts a method for wireless communications.

FIG. 18 depicts a method for wireless communications.

FIG. 19 depicts a method for wireless communications.

FIG. 20 depicts aspects of an example communications device.

### DETAILED DESCRIPTION

Aspects of the present disclosure provide apparatuses, methods, processing systems, and computer-readable mediums for Doppler frequency mitigation in reconfigurable intelligent surface (RIS) assisted communications.

In certain wireless systems, reconfigurable (or reflective) intelligent surfaces (RISs) may be deployed to reflect impinging beams/signals in desired directions. A RIS generally refers to a low-cost array of passive and reconfigurable reflecting elements that can extend coverage and boost spectral efficiency. A RIS may be configurable, via a RIS controller, to allow a network entity to enhance the visibility of an end-to-end channel for a target UE.

When a network entity (e.g., a base station, such as a gNB) communicates with a UE in high-speed motion, if that UE's movement direction is not perpendicular to the incoming signal direction, the received signal at the UE can suffer from one or more Doppler frequencies. Doppler frequencies refer to the change in frequency of radio waves caused by the relative motion between the transmitting and receiving antennas. As a result of Doppler frequencies, the frequency being received at the UE can be shifted (an increase or decrease) relative to the frequency which was originally transmitted by the network entity. This frequency shift, if not compensated for, can cause signal interference and degradation, which may impact signal reception, decoding, and channel state information (CSI) measurements.

In RIS assisted communication usage cases, a UE may be receiving a transmitted signal from multiple paths (e.g., a combination of a direct link plus one or more reflective links via on or more RISs) which may result in two or more Doppler frequencies. While a UE may be able to compensate for one Doppler frequency, when a UE suffers from two or more Doppler frequencies (e.g., in RIS assisted communication usage cases), compensation may become increasingly difficult, or impossible, and as a result the channel status may become time variant. Channel status time variations may affect composite channel gain reducing CSI accuracy and further lead to scheduling errors that may cause decoding failure or spectrum efficiency loss. While Doppler frequencies may be mitigated, in part, through increasing the frequency of CSI reporting, an increase in CSI reporting would result in an increase in UL signaling overhead.

Certain aspects of the present disclosure provide techniques for mitigating the impact of multiple Doppler frequencies for RIS-assisted communications by configuring a RIS with a time-domain rotation factor. Based on the time-domain rotation factor, with a given period, a RIS controller may rotate reflection coefficients of RIS elements. By rotating the reflection coefficients, the composite channel gain degradation and fluctuation (e.g., channel status time variation) induced by the multiple Doppler frequencies may be reduced thereby increasing CSI report accuracy, without increasing CSI reporting frequency, which may improve spectrum efficiency.

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

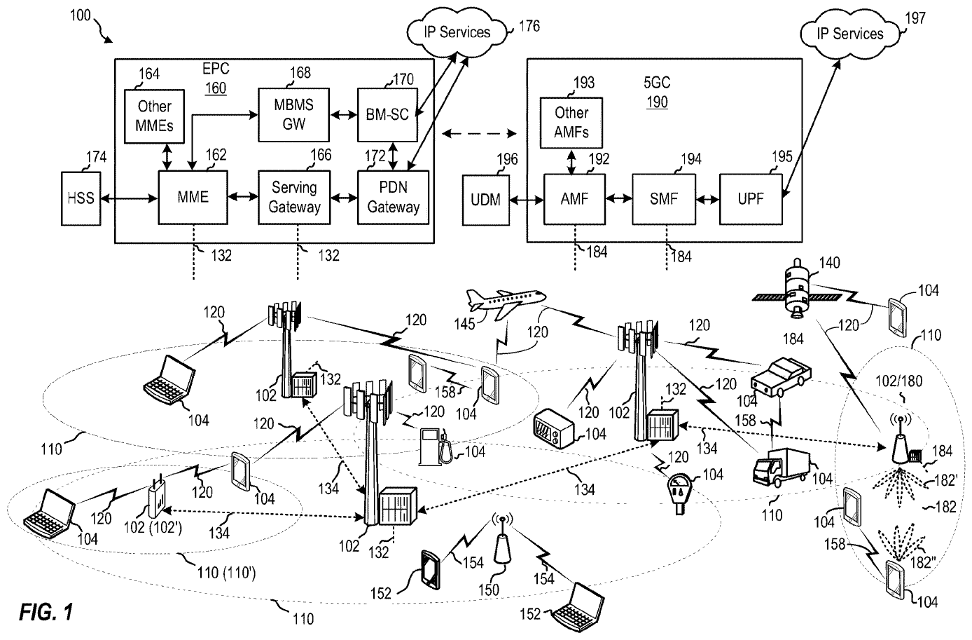

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and user equipments.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

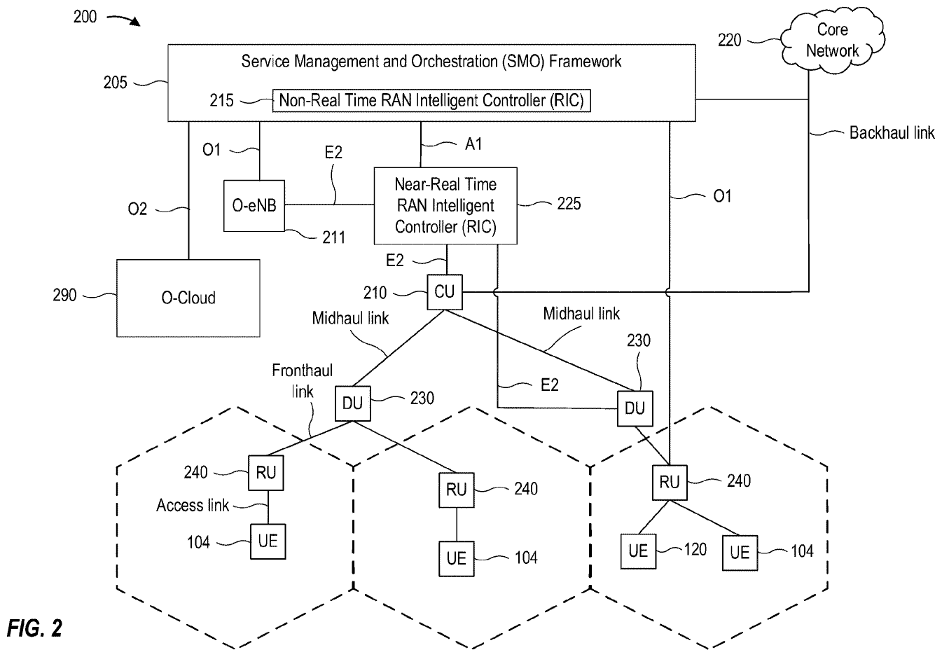

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-52,600 MHz, which is sometimes referred to (interchangeably) as a “millimeter wave” (“mmW” or “mmWave”). A base station configured to communicate using mmWave/near mmWave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QoS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUS 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUS 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

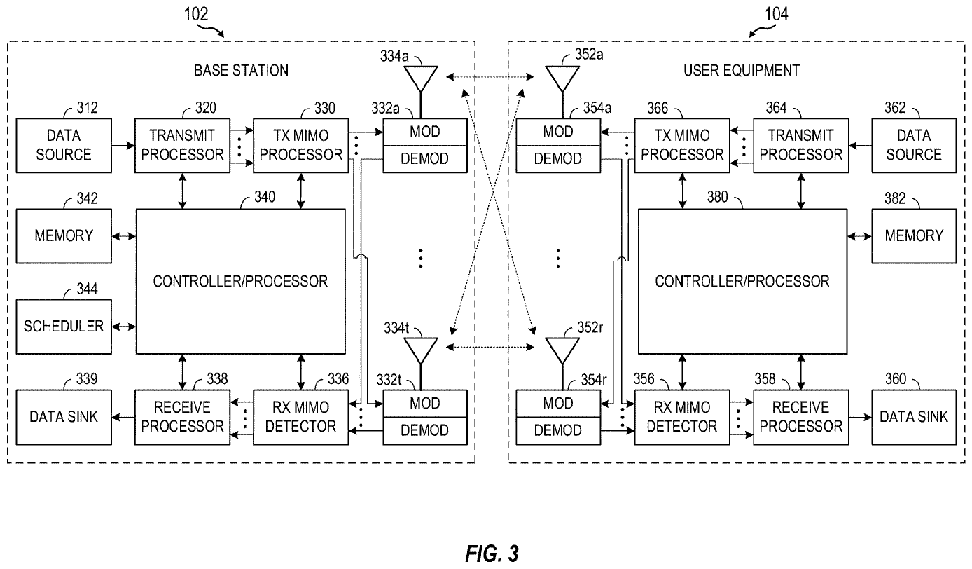

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

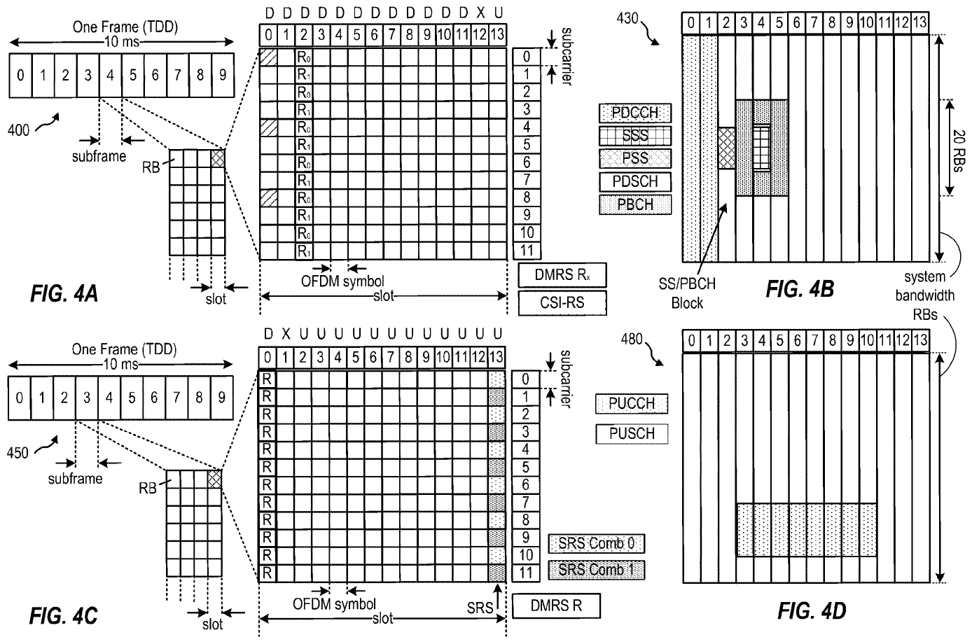

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where D is DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology u, there are 14 symbols/slot and 2μ slots/subframe. The subcarrier spacing and symbol length/duration are a function of the numerology. The subcarrier spacing may be equal to 2″× 15 kHz, where u is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Overview of Reconfigurable Intelligent Surface (RIS)

Massive multiple input multiple output (MIMO) configurations have the potential to significantly increase throughput. For example, MIMO may achieve a high beamforming gain by using active antenna units (AAUs) and may operate with individual radio frequency (RF) chains for each antenna port. Unfortunately, the use of the AAUs may significantly increase power consumption.

As discussed above, to further such advantages and extend coverage, reconfigurable (or reflective) intelligent surfaces (RISs) may be deployed to reflect impinging beams/signals in desired directions. RIS has been proposed as a low-cost array of passive and reconfigurable reflecting elements that can boost coverage and spectral efficiency. In some cases, the RISs may operate without the substantial power consumption when operating passively to only reflect or refract signals from a transmitter device towards a receiver device. In some cases, the reflection or refraction direction may be controlled by a network entity or a monitoring user equipment (UE). Configurability of a RIS allows a network to realize multiple anomalous reflections (each specified by a target incident direction and reflected direction pair) and assist its choice of UEs, by enhancing the end-to-end channel seen by them.

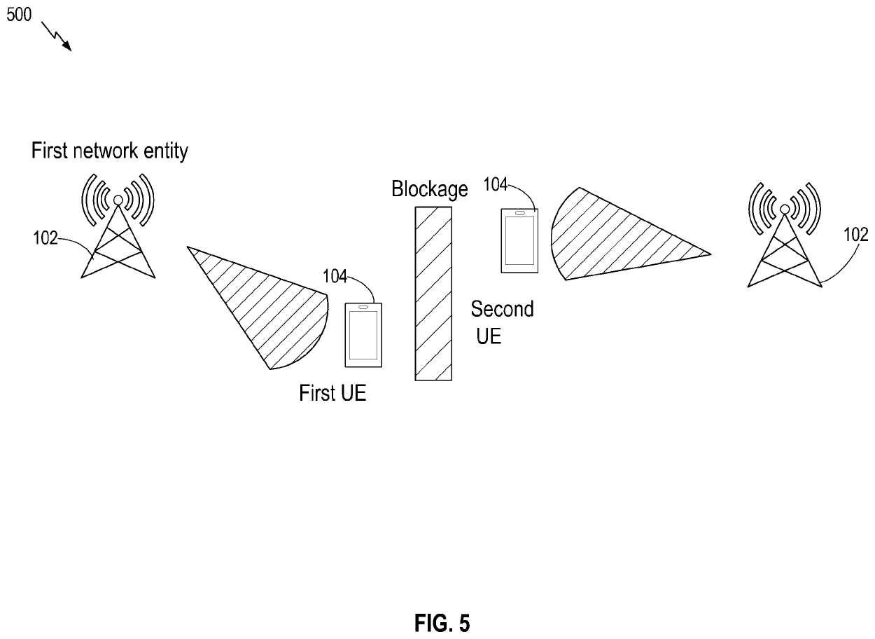

FIG. 5 illustrates an example deployment 500 with communication blockage between wireless communication devices. As shown, impeded by the blockage, a first network entity may only transmit to a first UE and may not reach a second UE, as the blockage prevents signals from reaching the second UE. Also, a second network entity may only transmit to the second UE and may not reach the first UE, as the blockage prevents the signals from reaching the first UE. The blockage also prevents the first UE from establishing sidelink communications with the second UE. As such, the second UE may not be able to communicate with the first network entity or the first UE, and the first UE may not be able to communicate with the second network entity or the second UE.

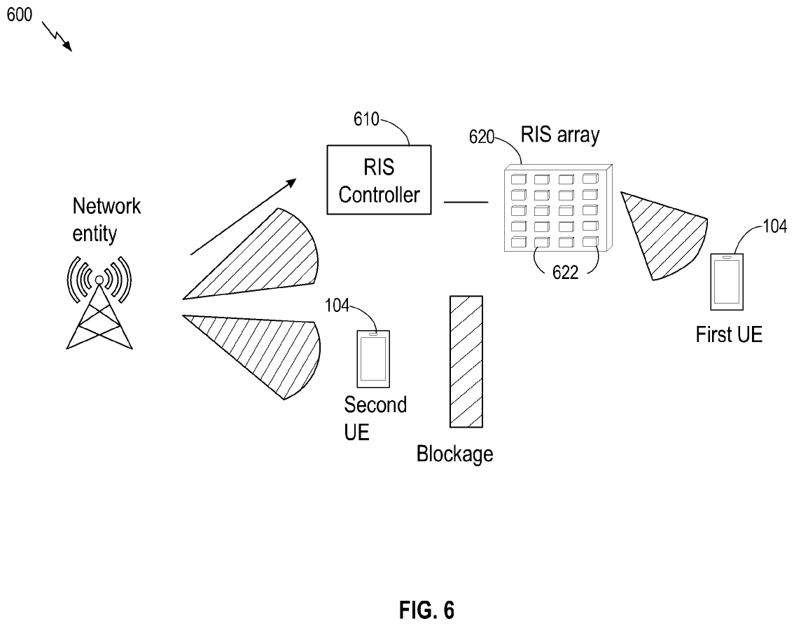

FIG. 6 illustrates an example deployment 600 using an array 620 of RIS elements 622 to overcome a blockage. As shown, the RIS elements may be introduced to reflect or otherwise re-radiate radio signals to bypass the blockage. For example, communications between a network entity and a first UE may be enabled by the RIS re-radiating one or more signals from the network entity towards the first UE and vice versa. Furthermore, the RIS elements can also be reconfigured via a RIS controller 610 (i.e., directing incoming and outgoing beams at different angles) to enable a second UE and the first UE to establish sidelink communications.

In some cases, an RIS may be a full-duplex (FD) device. FD communication allows for simultaneous transmission between devices. Half-duplex (HD) communication flows in one direction at a time. In operation, the RIS may immediately reflect a received signal from a transmitter device to a receiver device.

In some cases, a RIS may have a RIS-MT (mobile terminated) component (controller) for communicating with a gNB on the control-link, and a RIS-FWD (forwarding) component for forwarding/reflecting signals between a gNB and UE(s).

In some cases, a RIS may perform passive beamforming. For example, the RIS may receive signal power from a transmitter device proportional to a number of elements such as RIS elements of the RIS. When the RIS reflects or refracts a radio signal, one or more RIS elements may cause phase shifts to perform the beamforming or precoding. The phase shifts may be based on precoding weights (e.g., a multiplier or an offset of a time delay) applied to the one or more RIS elements. In some cases, for an array of RIS elements of the RIS, an RIS controller of the RIS may generate or specify a precoding weight for each RIS element.

In some cases, a RIS may be configured according to a (direction of a) target incident signal and a (direction of a) target reflected signal. A target incident signal generally refers to a signal travelling towards the RIS in a desired incident direction. A target reflected signal generally refers to a signal reflected by the RIS in a desired reflected direction (e.g., towards a targeted recipient). For example, the target reflected signal may be a reflected version of the target incident signal. As used herein, target incident direction generally refers to a desired direction of a target incident signal, while target reflected direction generally refers to a desired direction of a target reflected signal. Desired directions may be based on a desired objective, such as gain optimization as described in greater detail below. In some cases, signals incident on and/or reflected by a RIS that are not propagated in a target directions may be considered non-target and/or non-desired signals.

As described above, a RIS generally refers to a structure with a surface having a number of (densely-placed) reconfigurable meta-elements that can reflect or refract EM wave to target directions. A RIS structure may be formed of RIS elements that are reflective only, transmissive (refractive) only, or a combination thereof. In some cases, a RIS structure may be able to simultaneous transmit and reflect (STAR), which may be referred to as a hybrid-RIS or omni-RIS. Potential benefits of RIS structures include possible low cost (e.g., formed using relatively inexpensive positive intrinsic-negative/varactor diodes) and low power (e.g., with no radiation power, only control power for RIS configuration).

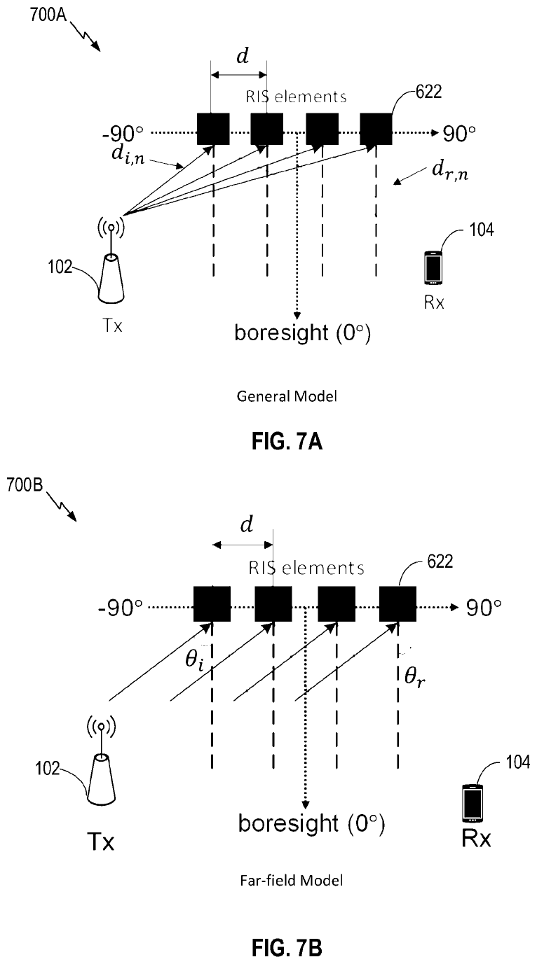

Reflective beamforming via a RIS may be understood with reference to the example diagrams 700A and 700B of FIGS. 7A and 7B. As illustrated (in FIG. 7B), a signal may be transmitted from a base station 102 towards an nth RIS element 622 at an incident (i) direction (d_{i,n}) that forms an incident angle (θᵢ) with a reference (perpendicular/boresight) line. The RIS element may be configured to reflect the signal toward a UE 104 at a reflection (r) direction (d_{r,n}) that forms a reflection angle (θᵣ) with the boresight line.

Reflection gain may for the incident angle {θ_{i,n}} and reflection angle {θ_{r,n}} may depend on whether the RIS elements 622 are in the near-field region or far-field region of the base station 102 and/or UE 104. In a general case (e.g., near-field model shown in FIG. 7A), the reflection gain for the incident angle {θ_{i,n}} and reflection angle {θ_{r,n}} may be described as:

$$h = {\sum }_{n = 0}^{N - 1} {e}^{- j \frac{2 π ( ( {d}_{i , n} - {d}_{i , 0} ) + ( {d}_{r , n} - {d}_{r , 0} ) )}{λ}} \cdot {α}_{n} {e}^{j {ϕ}_{n}}$$

where αₙe^{jφ}^{ₙ} is the reflective coefficient of meta-element n. In the far-field case (e.g., shown in FIG. 7B), the reflection gain for the incident angle {θ_{i,n}} and reflection angle {θ_{r,n}} may be described as:

$$h = {\sum }_{n = 0}^{N - 1} {e}^{j \frac{2 π nd}{λ} ( sin {θ}_{i} + sin {θ}_{r} )} \cdot {α}_{n} {e}^{j {ϕ}_{n}} .$$

In some cases, it may be desirable to have the following conditions:

$${α}_{n} ≡ α , {ϕ}_{n} = - \frac{2 π nd}{λ} ( sin {θ}_{i} + sin {θ}_{r} ) .$$

As a practical matter, the values of {αₙ, φₙ} are typically derived from an enumerated set based on meta-element realization. For example, a finite number of configurations may be associated with a certain phase shift and magnitude response. This approach may help limit signaling overhead, allowing one of the configurations to be selected with a limited number of bits (e.g., a 2-bit value may select one of 4 configurations).

### Aspects Related to RIS Coefficient Rotation

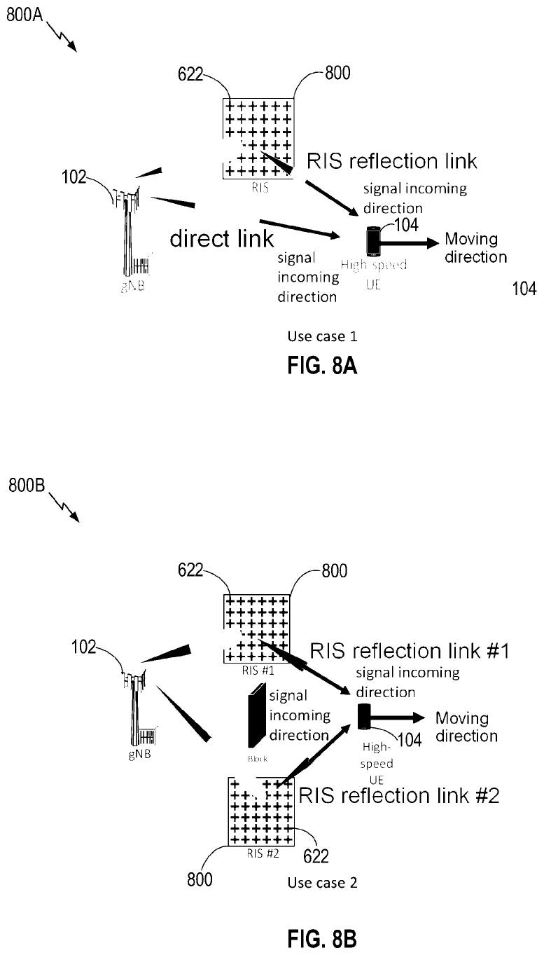

There may be certain challenges in various example use cases utilizing RIS-assisted communication with high-speed UEs (e.g., where a UE is on a high speed train-HST). A first example use case 800A is illustrated in FIG. 8A, in which a base station (e.g., a gNB) 102 communicates with a high-speed UE 104 via a direct link and at least one RIS reflection link (from a RIS 800). A first example use case 800B is illustrated in FIG. 8B, in which a base station 102 communicates with a high-speed UE 104 via two or more RIS reflection links (RIS reflection link #1 and RIS reflection link #2), but without a direct link (due to blocking in the illustrated example).

In these example use cases, if each of the links satisfies a line of sight (LOS) channel type or a certain non-LOS (NLOS) channel type with a dominant NLOS path that is much stronger than other NLOS paths, there may only be one dominant Doppler frequency at each link.

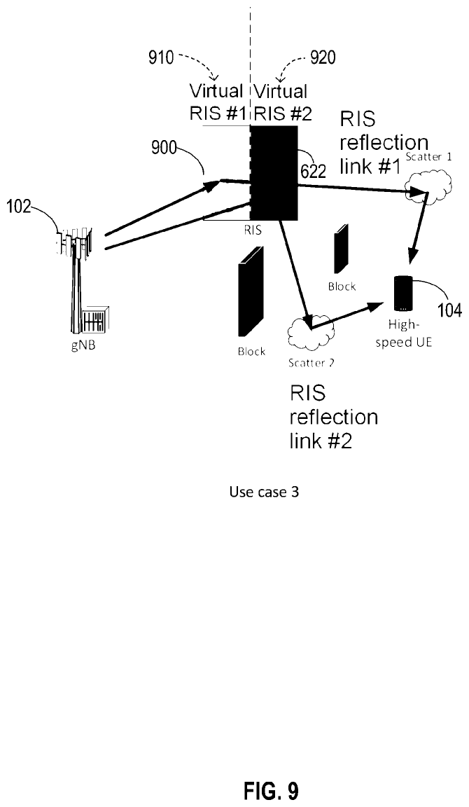

If there are multiple dominant NLOS paths in NLOS channel type, the path directions may be obtained by beam sweeping or channel estimation. As illustrated in FIG. 9, in such cases, a RIS surface 900 can be split into multiple sub-surfaces to generate multiple virtual RISs (e.g., a first virtual RIS 910 and a second virtual RIS 920). As illustrated, each sub-surface (virtual RIS) may be used to reflect the signal along one NLOS path. In such cases, there may also be only one dominant Doppler frequency at each link of virtual RIS.

As noted above, when a network entity (e.g., gNB) communicates with a UE moving at a high-speed (in a direction that is not perpendicular to the signal incoming direction), the received signal at UE may be impacted by a Doppler frequency. In the use case shown in FIG. 8A, if the signal incoming direction of direct link and signal incoming direction of RIS reflection link are different, the UE may suffer from the two different Doppler frequencies. Similarly, in the use case shown in FIG. 8B (and/or FIG. 9), if the signal incoming direction of the first (virtual) RIS reflection link #1 and the signal incoming direction of (virtual) RIS reflection link #2 are different, UE received signal(s) may suffer from the two different Doppler frequencies.

As noted above, while a UE may be able to compensate for one Doppler frequency, when a UE suffers from two or more Doppler frequencies, compensation may become increasingly difficult, or impossible. As a result, the channel status may become time variant. Channel status time variations may affect composite channel gain reducing CSI accuracy and further lead to scheduling errors that may cause decoding failure or spectrum efficiency loss. While Doppler frequencies may be mitigated, in part, through increasing the frequency of CSI reporting, an increase in CSI reporting would result in an increase in UL signaling overhead.

Certain aspects of the present disclosure provide techniques for mitigating the impact of multiple Doppler frequencies for RIS-assisted communications by configuring a RIS with a time-domain rotation factor. Based on the time-domain rotation factor, with a given period, a RIS controller may rotate reflection coefficients of RIS elements. By rotating the reflection coefficients, the composite channel gain degradation and channel status time variation induced by the multiple Doppler frequencies may be reduced.

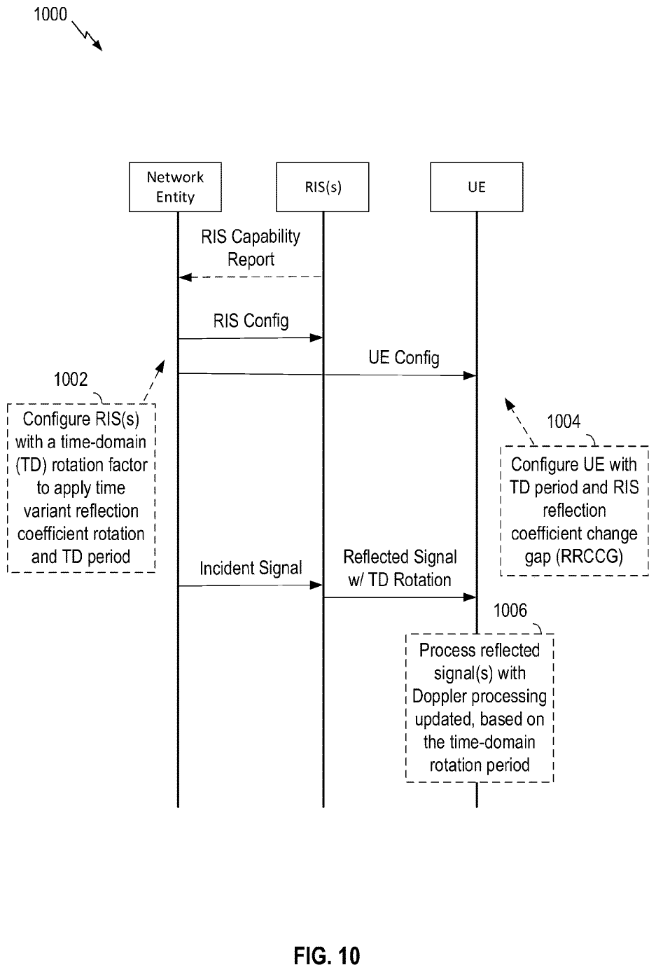

Techniques for mitigating the impact of multiple Doppler frequencies for RIS-assisted communications, in accordance with certain aspects of the present disclosure, may be understood with reference to the call flow diagram 1000 of FIG. 10.

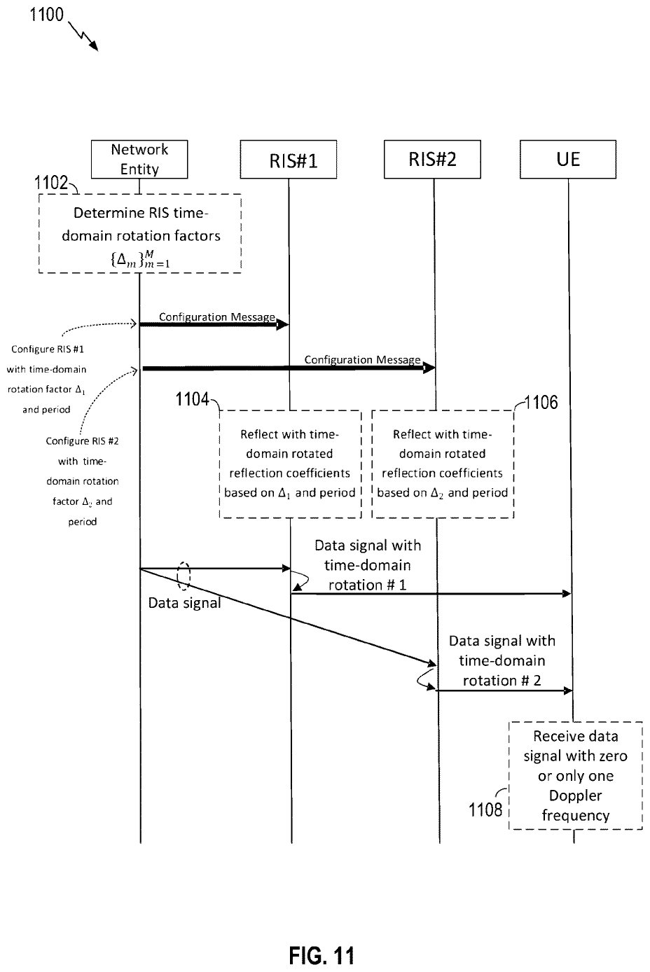

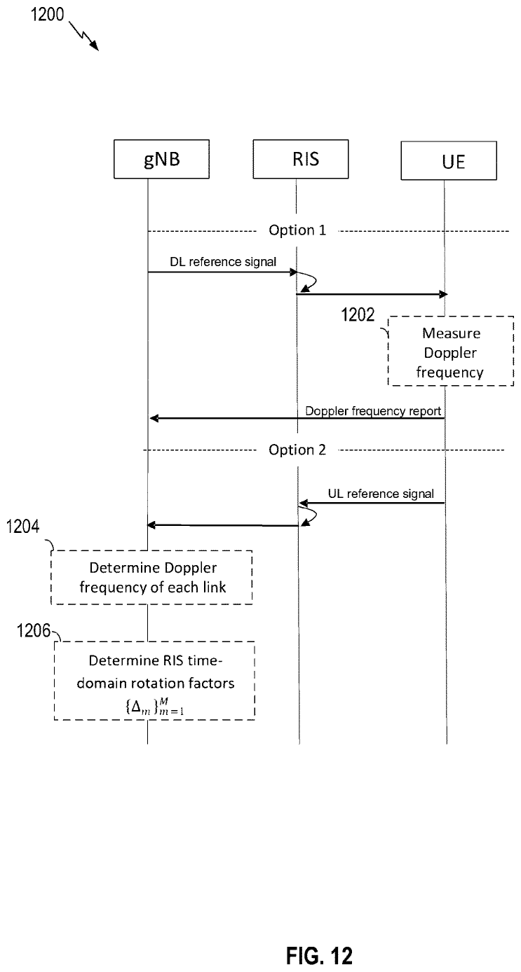

In some aspects, the UE shown in FIG. 10 (FIG. 11, and FIG. 12) may be an example of the UE 104 depicted and described with respect to FIGS. 1 and 3. In some aspects, the network entity shown in FIG. 10 (FIG. 11, and FIG. 12) may be an example of the BS 102 (e.g., a gNB) depicted and described with respect to FIGS. 1 and 3 or a disaggregated base station depicted and described with respect to FIG. 2.

As indicated at 1002, the network entity may configure at least one reconfigurable intelligent surface (RIS) with a time-domain rotation factor to apply time variant reflection coefficient rotation. As will be described in greater detail below, the time-domain rotation factor may be based on a Doppler frequency corresponding to a reflection link between the network entity the UE via the at least one RIS.

In some cases, the network entity may also configure the at least one RIS with a (TD rotation) period that determines how often coefficients of RIS elements of the at least one RIS are updated based on the time-domain rotation factor. As indicated at 1004, the network entity may also configure the UE with the TD rotation period. As indicated at 1006, the UE may process the reflected signal(s) with Doppler processing updated, based on the time-domain rotation period.

In some cases, the network entity may also indicate, to the UE, a RIS reflection coefficient change gap (RRCCG). The RRCCG may be based on a capability of the at least one RIS regarding RIS element coefficient change response time (which may be indicated, by a RIS controller, in a RIS capability report).

FIG. 11 illustrates an example call flow diagram for an example scenario with two RISs (RIS #1 and RIS #2). As illustrated at 1102, the network entity may determine the respective time-domain rotation factors for each of the RISs (Δ₁ and Δ₂) based on the Doppler frequency of the corresponding RIS reflection link and configure each RIS accordingly.

As illustrated at 1104 and 1106, each RIS may reflect its corresponding incident signal with time-domain rotated reflection coefficients, based on Δ₁ and Δ₂ and the TD rotation period.

As indicated at 1108, applying the time-domain rotation factor may result in a Doppler frequency for the corresponding signal received at the UE being zero (or only having one residual Doppler frequency, which may be more easily compensated for).

The call flow diagram 1200 of FIG. 12 illustrates various options for how the network entity may obtain the Doppler frequencies used to determine the TD rotation factors.

According to a first option (Option 1), the Doppler frequencies can be obtained by the network entity via downlink channel estimation, for example, based on a UE measurement report for downlink reference signals (DL RS) transmitted by the network entity. According to this option, the network entity may send DL-RS, such as channel state information reference signals (CSI-RS) or tracking reference signals (TRS), to the UE via a direct link (if a direct link exists) and/or a RIS reflection link.

In this case, as illustrated at 1202, the UE may measure the Doppler frequency (for a given RIS). The UE may measure the Doppler frequency of each link based on at least two CSI-RS. The UE may then report the measured Doppler frequency for each link, for the network entity to use to determine the TD rotation factor(s).

In some cases, the UE may be configured with a period for reporting the Doppler frequency that is larger than a period of CSI-RS transmission. This may help decrease the UL signaling overhead and radio resource consumption, when compared with reporting the Doppler frequency after receiving every CSI-RS.

According to a second option (Option 2), the Doppler frequencies can be obtained by the network entity via uplink channel estimation. According to this option, the UE may transmit uplink RS (UL RS), such as sounding reference signals (SRS), via a direct link (if a direct link exists) and/or a RIS reflection link. As indicated at 1204, the network entity may then measure the Doppler frequency of each link.

Regardless of which option is used, at 1206, the network entity may determine the TD rotation factors for each link based on the Doppler frequencies.

In some cases, to avoid mutual interference or measurement result confusion, for either option, the measurement on the Doppler frequency of each link may be performed at different time occasions. For example, the network entity may configure (via RIS controllers) switching off of all the RISs, in order to measure a direct link. The network entity may then configure switching on each RIS, in turn, to measure Doppler frequency for each RIS reflection link.

After measuring the Doppler frequency of a direct link (denoted as

$${f}_{i}^{d i r e c t} )$$

and the Doppler frequency of a RIS reflection link (denoted as

$${f}_{d , m}^{RIS} ) ,$$

the network entity may determine the RIS time-domain rotation factors

$${\{ {Δ}_{m} \}}_{m = 1}^{M} .$$

The general objective the RIS time-domain rotation factors is to compensate the relative Doppler frequencies of multiple links, such that the UE suffers from zero or only one Doppler frequency.

There are various options to achieve this objective. For example, according to a first option, if a direct link exists and the network entity does not compensate for the Doppler frequency in the direct link, an ideal time-domain rotation coefficient (a RIS coefficient with rotation factor applied) for RIS #m may be expressed as:

$${e}^{- j 2 π \cdot ( {f}_{d , m}^{RIS} - {f}_{d}^{direct} ) \cdot t} .$$

Thus, the RIS time-domain rotation factor for any RIS #m is:

$${Δ}_{m} = - ( {f}_{d , m}^{RIS} - {f}_{d}^{direct} ) .$$

In this way, the UE may only suffer from one Doppler frequency (e.g., assuming there is only one dominant Doppler frequency in the direct link and each RIS reflection link).

According to another option, if a direct link exists and the network entity does compensate for the Doppler frequency in the direct link, the ideal time-domain rotation coefficient for RIS #m may be expressed as:

$${e}^{- j 2 π \cdot {f}_{d , m}^{RIS} \cdot t} .$$

Thus, the RIS time-domain rotation factor for any RIS #m is:

$${Δ}_{m} = - {f}_{d , m}^{RIS} .$$

In this way, the UE may not suffer from any Doppler frequency.

There are various options to determine the RIS time-domain rotation factors if a direct link does not exist. According to one option, the ideal time-domain rotation coefficient may be expressed as:

$${e}^{- j 2 π \cdot ( {f}_{d , m}^{RIS} - {f}_{d , {m}^{*}}^{RIS} ) \cdot t} for RIS \# m \neq {m}^{*} ,$$

where m* is common for all RISs and can be selected arbitrarily. Thus, the RIS time-domain rotation factor for RIS #m is:

$${Δ}_{m} = - ( {f}_{d , m}^{RIS} - {f}_{d , {m}^{*}}^{RIS} ) .$$

In this way, UE suffers from only one Doppler frequency. According to another option, the ideal time-domain rotation coefficient may be expressed as:

$${e}^{- j 2 π \cdot {f}_{d , m}^{RIS} \cdot t}$$

for any RIS #m. Thus, the RIS time-domain rotation factor for RIS #m is

$${Δ}_{m} = - {f}_{d , m}^{RIS} .$$

In this way, the UE may not suffer from any Doppler frequency.

Once the time-domain rotation factors are determined, the network entity may configure the corresponding RIS(s), for example by signaling the corresponding RIS controller(s). The network entity may configure time-domain rotation factor Δₘ for RIS #m or virtual RIS (sub-surface) #m. Because the Doppler frequency of the moving UE is normally variant, this configuration may be conveyed via a dynamic signaling message, such as downlink control information (DCI). In some cases, however, a configuration may be conveyed via radio resource control (RRC) or medium access control (MAC) control element (CE) signaling.

A RIS may take some response time in order to adjust its meta-element reflection coefficient. As noted above, such response time may be reported as a RIS capability. For example, the length of response time may be on the order of micro-seconds (us), for certain RIS types.

Thus, a RIS may report a capability regarding a meta-element change response time to the network entity. The network entity may then configure a reflection coefficient rotation period Tᵣₒₜₐₜₑ to a RIS. This reflection coefficient rotation period may correspond to how often reflection coefficients are to be updated (rotated). In some cases, the reflection coefficient rotation period may be larger than the reported response time. As an example, for a numerology with subcarrier spacing (SCS) of 30 kHz, if the minimum timing gap is 2 μs, this accounts for approximately 5.6% of one OFDM symbol length (35.7 μs) and about 0.4% of one slot (500 μs).

Considering channel estimation based on one demodulation reference signal (DMRS) symbol may be used for signal reception of multiple symbols or the whole slot, it may be best if the RIS rotation coefficient does not change until the next DMRS symbol or in the duration of one slot. For example, the reflection coefficient rotation period may be equal to the duration of one slot or multiple slots, depending on an absolute value of Doppler frequency. In general, the larger the absolute value of a Doppler frequency, the shorter the reflection coefficient rotation period.

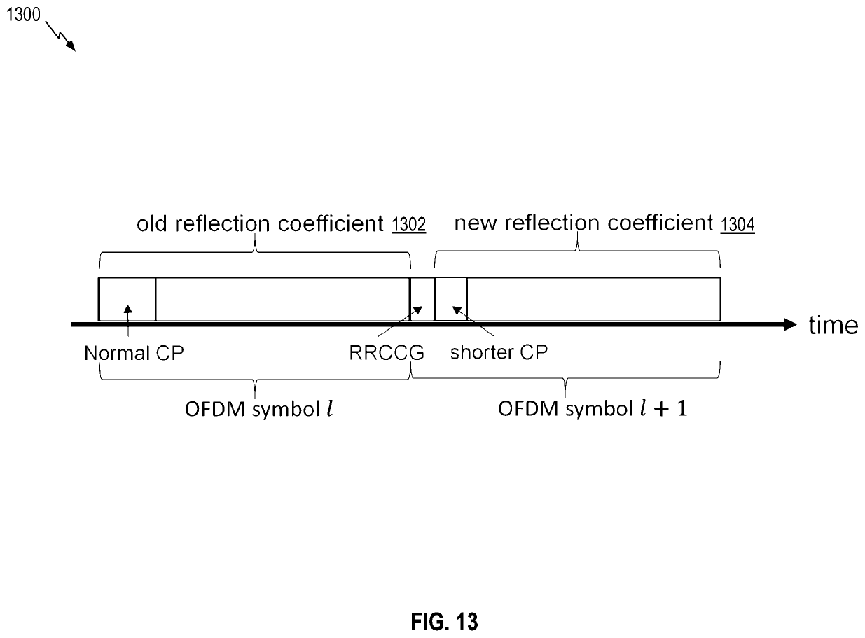

As noted above, and as illustrated in the timing diagram 1300 of FIG. 13, when the network entity configures a time-domain rotation factor, a gap referred to as a RIS reflection coefficient change gap (RRCCG) may be allocated. As illustrated in FIG. 13, the RRCCG may correspond to a period of time when the RIS reflection coefficient is changed, from an old reflection coefficient 1302 applied in a first OFDM symbol l to a new reflection coefficient 1304 applied in OFDM symbol l+1. During the RRCCG, a data signal or reference signal may not be transmitted in the RIS reflection link.

As shown in the illustrated example, if the length of the RRCCG is much smaller than CP length, the RRCCG may be placed at the beginning of the relevant OFDM symbol (l+1). Thus, the OFDM symbol l+1 following the RRCCG has shorter CP. In some cases, the length of such shorter CP or the length of RRCCG can be configured by the network entity. The network entity may determine this length based on the RIS capability report on meta-element change response time.

If the length of RRCCG is similar to or larger than CP, the RRCCG may be placed at a blank OFDM symbol. In general, the position of the RRCCG, shorter CP, and/or blank OFDM symbol may also be configured for the UE.

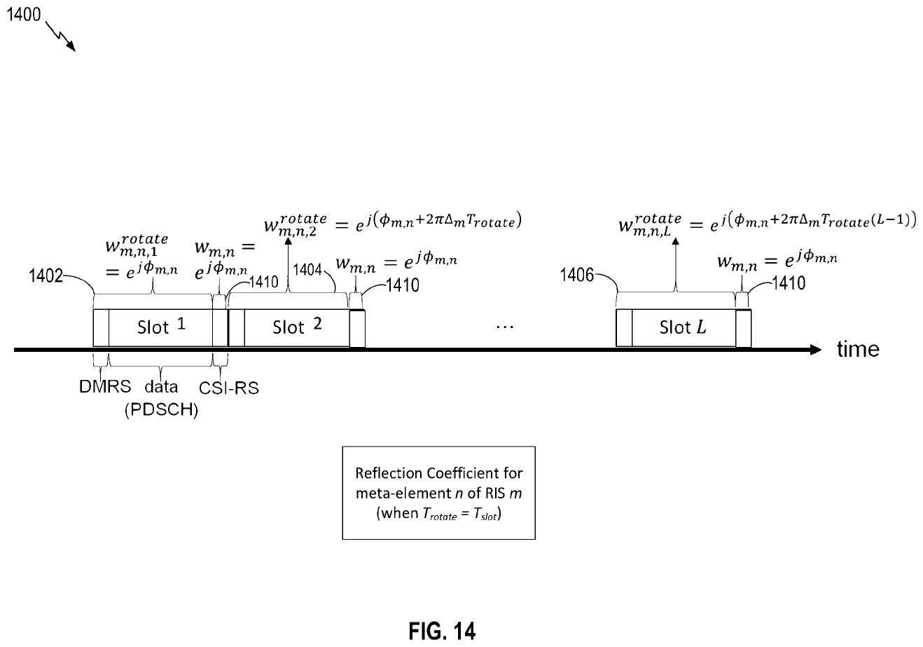

As illustrated in the timing diagram 1400 of FIG. 14, after receiving the configuration of time-domain rotation factor Δₘ and period Tᵣₒₜₐₜₑ, RIS m uses these parameters to determine the reflection coefficient of each symbol/slot. In the illustrated example, Tᵣₒₜₐₜₑ=Tₛₗₒₜ.

For example, assuming a basic reflection coefficient for meta-element n of RIS m, when Tᵣₒₜₐₜₑ=Tₛₗₒₜ, is:

$${w}_{m , n} = {e}^{j {ϕ}_{m , n}} \cdot ,$$

which is determined based on the target incident direction θ_{i,m} and reflection direction θ_{r,m}. The “rotated” reflection coefficient for meta-element n of RIS m is

$${w}_{m , n , l}^{rotate} = {e}^{j ( {ϕ}_{m , n} + 2 {πΔ}_{m} {T}_{rotate} ( l - 1 ) )} .$$

in the duration Tᵣₒₜₐₜₑ (l−1)≤t<Tᵣₒₜₐₜₑl, l=1, 2, . . . is the index of time-domain rotation period. Thus, as shown at 1402, at slot 1 (l=1):

$${w}_{m , n , l}^{rotate} = {e}^{j ( {ϕ}_{m , n} )} ,$$

As shown at 1404, at slot 2 (l=2):

$${w}_{m , n , l}^{rotate} = {e}^{j ( {ϕ}_{m , n} + 2 {πΔ}_{m} {T}_{rotate} )} ;$$

and
As shown at 1406, at slot L:

$${w}_{m , n , l}^{rotate} = {e}^{j ( {ϕ}_{m , n} + 2 {πΔ}_{m} {T}_{rotate} ( L - 1 ) )} .$$

In some cases, the RIS meta-element reflection coefficient may be selected from a limited set of candidate values. Thus the actual reflection coefficient used may be the candidate value which is the closest to

$${w}_{m , n , l}^{rotate} .$$

To measure the Doppler frequency, some symbols (e.g., at end of each slot) may be used for CSI-RS. Thus, as illustrated at 1410, for these symbols, a RIS uses the basic reflection coefficient without reflection coefficient rotation (w_{m,n}=e^{jφ}^{_{m,n}}).

Due to the rotation applied at the RIS, the UE may receive the signals from the direct link and RIS reflection link with zero or one Doppler frequency. If the signal is received with zero Doppler frequency, the UE may take no action to compensate the Doppler frequency offset. If the signal is received with one Doppler frequency, the UE may take action to compensate the Doppler frequency offset. For example, the UE may estimate the Doppler frequency f_{d} based on DMRS, and then multiply a sequence e^{-j2πf}^{_{d}}^{kT}^{ₛ} to the received signal, where Tₛ is the sampling interval, k is the sample index.

As described above, the network entity may indicate the time-domain rotation period to the UE, which can help with the UE reception. For example, when a new period occurs, the UE may reset its Doppler estimation or compensation based on DMRS. In some cases, the network entity indicates the RIS reflection coefficient change gap to UE, during which UE may not expect to receive a signal from RIS. This may impact rate matching and channel measurement performed at the UE.

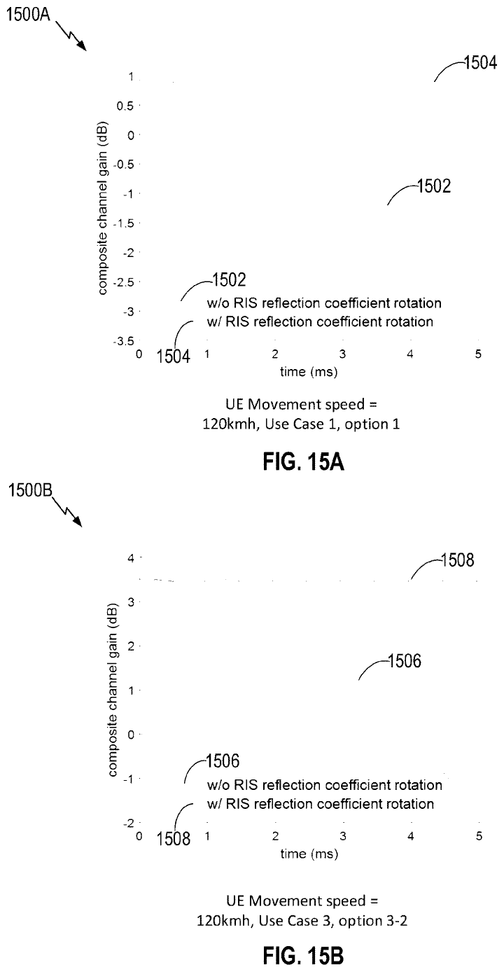

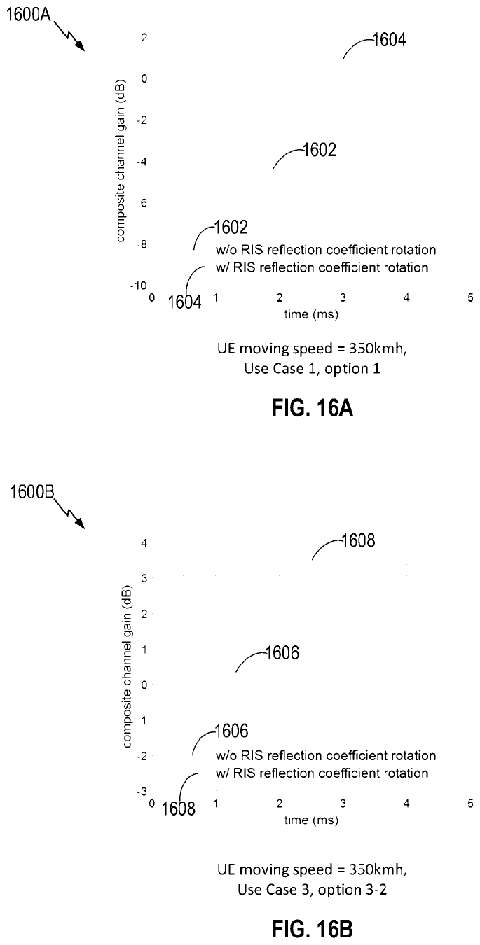

FIGS. 15A, 15B, 16A, and 16B depict example simulation results that demonstrate potential performance improvements achievable using RIS time domain rotation factors, according to certain aspects of the present disclosure.

For simplicity, the simulations may assume a narrow-band signal is used, which can be understood as the signal at one subcarrier if wideband OFDM signal is transmitted, with a carrier frequency f_{c}=3.5 GHZ, and the UE moving velocity v=120 km/h (e.g., highway speed) for FIGS. 15A and 15B or 350 km/h (e.g., a high-speed train) FIGS. 16A and 16B.

The simulations may also assume a direct link channel response h_{direct} and RIS reflection link channel response h_{RIS,m} are Rayleigh-distributed variables with identical mean value and variance (the coherent joint transmission may be achieved by proper RIS beamforming weight).

The angles between each link and UE moving direction are θ_{direct} and θ_{RIS,m}, so the Doppler frequencies at each link are:

$${f}_{d}^{direct} = {f}_{d , UE} cos {θ}_{direct} ,$$

$${f}_{d , m}^{RIS} = {f}_{d , UE} cos {θ}_{RIS , m} .$$

FIGS. 15A and 16A shows simulation results (for UE speeds of 120 kmh and 350 kmh, respectively) for a first use case and option, with a direct link and one RIS reflection link, where the network entity does not compensate for Doppler frequency and RIS rotates reflection coefficient based on the equation:

$${Δ}_{m} = - ( {f}_{d , m}^{RIS} - {f}_{d}^{direct} ) .$$

Without RIS reflection coefficient rotation, as indicated at 1502 and 1602, the received signal is

$$y ( k ) = {h}_{direct} {e}^{j 2 π {f}_{d}^{direct} {kT}_{s}} + {h}_{RIS , m} {e}^{j 2 π {f}_{d , m}^{RIS} {kT}_{s}} .$$

With RIS reflection coefficient rotation, as indicated at 1504 and 1604, the received signal is

$$y ( k ) = {h}_{direct} {e}^{j 2 π {f}_{d}^{direct} {kT}_{s}} + {h}_{RIS , m} {e}^{j 2 π {f}_{d , m}^{RIS} {kT}_{s}} {w}_{m , n , l}^{rotate} = {h}_{direct} {e}^{j 2 π {f}_{d}^{direct} {kT}_{s}} + {h}_{RIS , m} {e}^{j 2 π {f}_{d , m}^{RIS} {kT}_{s}} \cdot {e}^{j 2 {πΔ}_{m} {T}_{rotate} ( l - 1 )}$$

when the sample position k lies in the rotation period l, i.e., Tᵣₒₜₐₜₑ(l−1)≤kTₛ<Tᵣₒₜₐₜₑl.

FIGS. 15B and 16B show simulation results (for UE speeds of 120 kmh and 350 kmh, respectively) for a second use case and option, with two RIS reflection links. In this case, the RIS rotates the reflection coefficient based on:

$${Δ}_{m} = - {f}_{d , m}^{RIS} .$$

Without RIS reflection coefficient rotation, as indicated at 1506 and 1606, the received signal is

$$y ( k ) = {h}_{RIS , 1} {e}^{j 2 π {f}_{d , 1}^{RIS} {kT}_{s}} + {h}_{RIS , 2} {e}^{j 2 π {f}_{d , 2}^{RIS} {kT}_{s}} .$$

With RIS reflection coefficient rotation, as indicated at 1508 and 1608, the received signal is

$$y ( k ) = {h}_{RIS , 1} {e}^{j 2 π {f}_{d , 1}^{RIS} {kT}_{s}} {w}_{1 , n , l}^{rotate} + {h}_{RIS , 2} {e}^{j 2 π {f}_{d , 2}^{RIS} {kT}_{s}} {w}_{2 , n , l}^{rotate} = {h}_{RIS , 2} {e}^{j 2 π {f}_{d , 2}^{RIS} {kT}_{s}} \cdot {e}^{j 2 {πΔ}_{1} {T}_{rotate} ( l - 1 )} + {h}_{RIS , 1} {e}^{j 2 π {f}_{d , 1}^{RIS} {kT}_{s}} \cdot {e}^{j 2 {πΔ}_{2} {T}_{rotate} ( l - 1 )}$$

when the sample position k lies in the rotation period l, i.e., Tᵣₒₜₐₜₑ (l−1)≤kTₛ<Tᵣₒₜₐₜₑl.

As demonstrated by the example simulation results, if RIS reflection coefficient rotation is not applied, the composite channel gain (involving the combining of the channel gains of all links) may suffer from degradation and fluctuation, which may lead to CSI inaccuracy, scheduling error and spectrum efficiency loss. On the other hand, if RIS reflection coefficient rotation is applied, the composite channel gain degradation and fluctuation are greatly reduced, which may improve CSI accuracy and increase spectrum efficiency.

In some cases, to support the techniques proposed herein, various signaling mechanisms may be utilized (e.g., and defined in wireless standard specifications). For example, these signaling mechanisms may include signaling messages that allows a network entity (e.g., gNB) to configure a RIS (or virtual RIS) with a time-domain rotation factor and period. The signaling messages may also include messages that allow a RIS to report the capability on meta-element change response time to gNB. In some cases, signaling messages may allow a network entity to configure a shorter CP for an OFDM symbol due to RIS reflection coefficient change gap (RRCCG). In some cases, signaling messages may allow the network entity to configure a UE with the position of an RRCCG, shorter CP or blank OFDM symbol to UE. As noted above, during the gap, the UE may not expect to receive signal from RIS. This may impact the rate matching and channel measurement. In some cases, the network entity may configure the UE with the time-domain rotation period, which may help with the UE signal reception. For example, when a new period occurs, the UE may reset its DMRS-based Doppler estimation or compensation.

### Example Operations

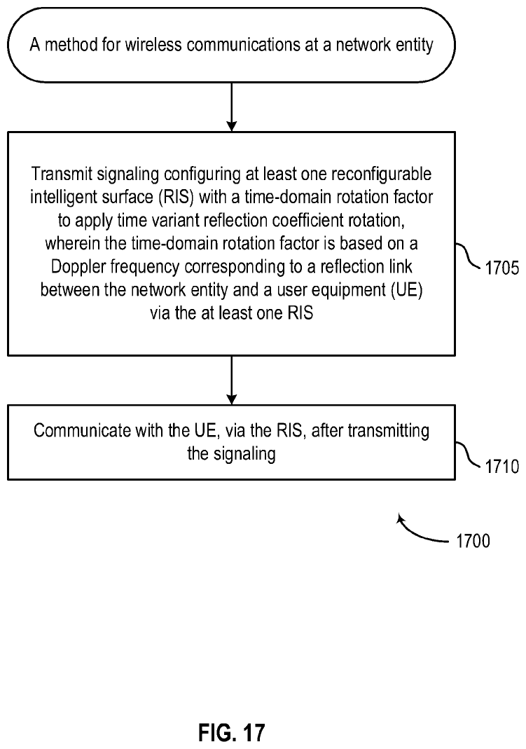

FIG. 17 shows an example of a method 1700 of wireless communications at a network entity, such as a BS 102 of FIGS. 1 and 3, or a disaggregated base station as discussed with respect to FIG. 2.

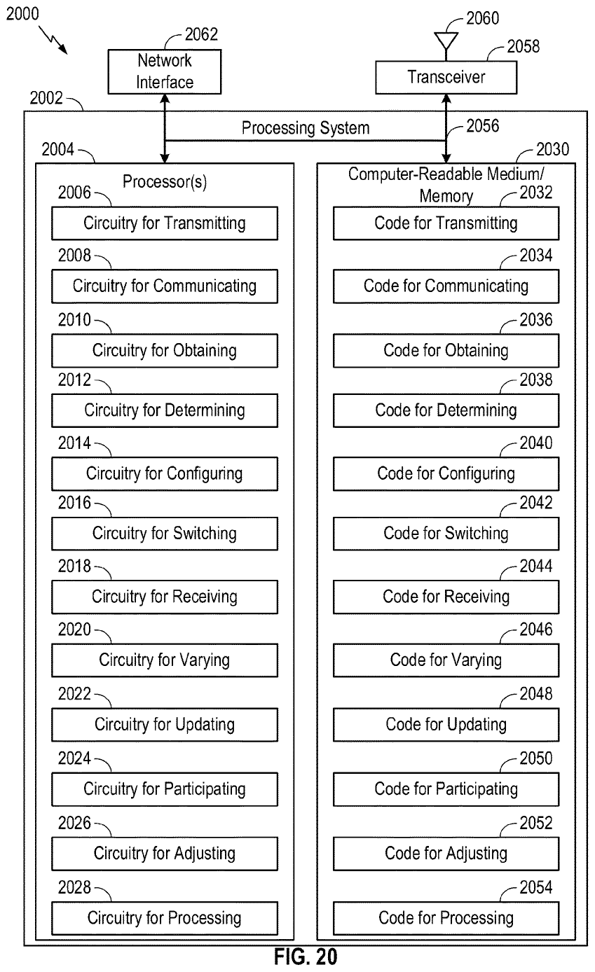

Method 1700 begins at step 1705 with transmitting signaling configuring at least one reconfigurable intelligent surface (RIS) with a time-domain rotation factor to apply time variant reflection coefficient rotation, wherein the time-domain rotation factor is based on a Doppler frequency corresponding to a reflection link between the network entity and a user equipment (UE) via the at least one RIS. In some cases, the operations of this step refer to, or may be performed by, circuitry for transmitting and/or code for transmitting as described with reference to FIG. 20.

Method 1700 then proceeds to step 1710 with communicating with the UE, via the RIS, after transmitting the signaling. In some cases, the operations of this step refer to, or may be performed by, circuitry for communicating and/or code for communicating as described with reference to FIG. 20.

In some aspects, the method 1700 further includes obtaining information regarding the Doppler frequency corresponding to the reflection link. In some cases, the operations of this step refer to, or may be performed by, circuitry for obtaining and/or code for obtaining as described with reference to FIG. 20.

In some aspects, the method 1700 further includes determining the time-domain rotation factor, based at least on the Doppler frequency corresponding to the reflection link. In some cases, the operations of this step refer to, or may be performed by, circuitry for determining and/or code for determining as described with reference to FIG. 20.

In some aspects, determination of the time-domain rotation factor depends on at least one of: whether a direct link exists between the network entity and the UE or whether the network entity compensates for Doppler frequency corresponding to the direct link.

In some aspects, obtaining information regarding the Doppler frequency comprises: receiving a measurement report from the UE indicating the Doppler frequency.

In some aspects, the method 1700 further includes configuring the at least one RIS to use a basic reflection coefficient without rotation in at least a portion of some symbols to allow the UE to measure the Doppler frequency. In some cases, the operations of this step refer to, or may be performed by, circuitry for configuring and/or code for configuring as described with reference to FIG. 20.

In some aspects, obtaining information regarding the Doppler frequency comprises: determining the Doppler frequency based on measurements of an uplink reference signal from the UE.

In some aspects, the method 1700 further includes switching off the at least one RIS to determine a Doppler frequency corresponding to at least one of: a direct link between the network entity and the UE, or a reflective link between the network entity and the UE, via at least one other RIS. In some cases, the operations of this step refer to, or may be performed by, circuitry for switching and/or code for switching as described with reference to FIG. 20.

In some aspects, the method 1700 further includes determining a time-domain rotation period that determines how often coefficients of RIS elements of the at least one RIS are updated based on the time-domain rotation factor. In some cases, the operations of this step refer to, or may be performed by, circuitry for determining and/or code for determining as described with reference to FIG. 20.

In some aspects, the method 1700 further includes receiving signaling indicating a capability of the at least one RIS regarding RIS element coefficient change response time, wherein the time-domain rotation period is determined based on the capability. In some cases, the operations of this step refer to, or may be performed by, circuitry for receiving and/or code for receiving as described with reference to FIG. 20.

In some aspects, the method 1700 further includes transmitting an indication of the time-domain rotation period to at least one of: the UE or the at least one RIS. In some cases, the operations of this step refer to, or may be performed by, circuitry for transmitting and/or code for transmitting as described with reference to FIG. 20.

In some aspects, the method 1700 further includes determining a time gap for the at least one RIS to change RIS element coefficients based on the time-domain rotation factor. In some cases, the operations of this step refer to, or may be performed by, circuitry for determining and/or code for determining as described with reference to FIG. 20.

In some aspects, the method 1700 further includes transmitting an indication of the time gap to at least one of: the UE or the at least one RIS. In some cases, the operations of this step refer to, or may be performed by, circuitry for transmitting and/or code for transmitting as described with reference to FIG. 20.

In one aspect, method 1700, or any aspect related to it, may be performed by an apparatus, such as communications device 2000 of FIG. 20, which includes various components operable, configured, or adapted to perform the method 1700. Communications device 2000 is described below in further detail.

Note that FIG. 17 is just one example of a method, and other methods including fewer, additional, or alternative steps are possible consistent with this disclosure.

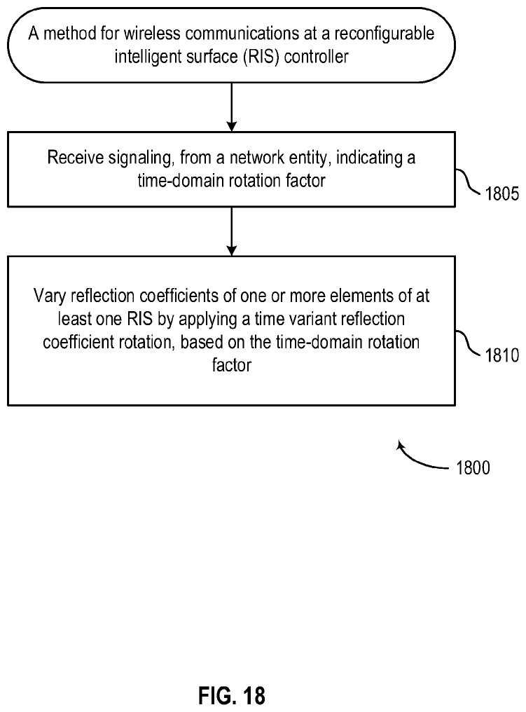

FIG. 18 shows an example of a method 1800 of wireless communications at a reconfigurable intelligent surface (RIS) controller, such as a UE 104 of FIGS. 1 and 3.

Method 1800 begins at step 1805 with receiving signaling, from a network entity, indicating a time-domain rotation factor. In some cases, the operations of this step refer to, or may be performed by, circuitry for receiving and/or code for receiving as described with reference to FIG. 20.

Method 1800 then proceeds to step 1810 with varying reflection coefficients of one or more elements of at least one RIS by applying a time variant reflection coefficient rotation, based on the time-domain rotation factor. In some cases, the operations of this step refer to, or may be performed by, circuitry for varying and/or code for varying as described with reference to FIG. 20.

In some aspects, the method 1800 further includes receiving signaling, from the network entity, to configure the at least one RIS to use a basic reflection coefficient without rotation in at least a portion of some symbols. In some cases, the operations of this step refer to, or may be performed by, circuitry for receiving and/or code for receiving as described with reference to FIG. 20.

In some aspects, the method 1800 further includes determining a time-domain rotation period that determines how often coefficients of RIS elements of the at least one RIS are updated based on the time-domain rotation factor. In some cases, the operations of this step refer to, or may be performed by, circuitry for determining and/or code for determining as described with reference to FIG. 20.

In some aspects, the method 1800 further includes transmitting signaling, to the network entity, indicating a capability of the at least one RIS regarding RIS element coefficient change response time, wherein the time-domain rotation period is determined based on the capability. In some cases, the operations of this step refer to, or may be performed by, circuitry for transmitting and/or code for transmitting as described with reference to FIG. 20.

In some aspects, the method 1800 further includes receiving an indication of the time-domain rotation period from the network entity. In some cases, the operations of this step refer to, or may be performed by, circuitry for receiving and/or code for receiving as described with reference to FIG. 20.

In some aspects, the method 1800 further includes determining a time gap for changing RIS element coefficients based on the time-domain rotation factor. In some cases, the operations of this step refer to, or may be performed by, circuitry for determining and/or code for determining as described with reference to FIG. 20.

In some aspects, the method 1800 further includes receiving an indication of the time gap from the network entity. In some cases, the operations of this step refer to, or may be performed by, circuitry for receiving and/or code for receiving as described with reference to FIG. 20.

In one aspect, method 1800, or any aspect related to it, may be performed by an apparatus, such as communications device 2000 of FIG. 20, which includes various components operable, configured, or adapted to perform the method 1800. Communications device 2000 is described below in further detail.

Note that FIG. 18 is just one example of a method, and other methods including fewer, additional, or alternative steps are possible consistent with this disclosure.

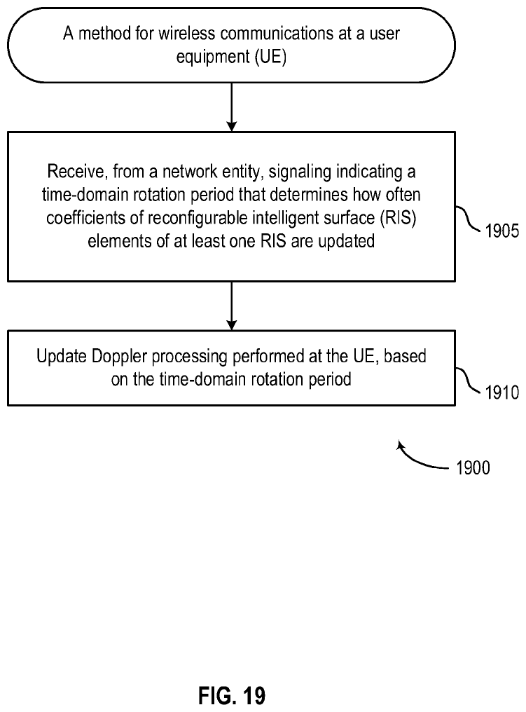

FIG. 19 shows an example of a method 1900 of wireless communications at a user equipment (UE), such as a UE 104 of FIGS. 1 and 3.

Method 1900 begins at step 1905 with receiving, from a network entity, signaling indicating a time-domain rotation period that determines how often coefficients of reconfigurable intelligent surface (RIS) elements of at least one RIS are updated. In some cases, the operations of this step refer to, or may be performed by, circuitry for receiving and/or code for receiving as described with reference to FIG. 20.

Method 1900 then proceeds to step 1910 with updating Doppler processing performed at the UE, based on the time-domain rotation period. In some cases, the operations of this step refer to, or may be performed by, circuitry for updating and/or code for updating as described with reference to FIG. 20.

In some aspects, the method 1900 further includes participating in a procedure to measure a Doppler frequency corresponding to a reflection link between the network entity and the UE, via the at least one RIS. In some cases, the operations of this step refer to, or may be performed by, circuitry for participating and/or code for participating as described with reference to FIG. 20.

In some aspects, participating in the procedure to measure the Doppler frequency corresponding to the reflection link comprises: measuring downlink reference signals reflected from the at least one RIS; determining the Doppler frequency corresponding to the reflection link, based on the measuring; and transmitting a measurement report indicating the Doppler frequency corresponding to the reflection link.

In some aspects, participating in the procedure to measure the Doppler frequency corresponding to the reflection link comprises: transmitting an uplink reference signal from the UE.

In some aspects, the method 1900 further includes receiving, from the network entity, signaling indicating a time gap for the at least one RIS to change RIS element coefficients. In some cases, the operations of this step refer to, or may be performed by, circuitry for receiving and/or code for receiving as described with reference to FIG. 20.

In some aspects, the method 1900 further includes adjusting at least one of rate matching or channel measurement, based on the time gap. In some cases, the operations of this step refer to, or may be performed by, circuitry for adjusting and/or code for adjusting as described with reference to FIG. 20.

In some aspects, the method 1900 further includes receiving data signals from at least a reflection link between the network entity and the UE, via the at least one RIS. In some cases, the operations of this step refer to, or may be performed by, circuitry for receiving and/or code for receiving as described with reference to FIG. 20.

In some aspects, the method 1900 further includes processing the data signals in a manner depending on whether the data signal are received with zero or at least one Doppler frequency. In some cases, the operations of this step refer to, or may be performed by, circuitry for processing and/or code for processing as described with reference to FIG. 20.

In some aspects, the processing comprises: taking action to compensate for a Doppler frequency offset if the data signals are received with at least one Doppler frequency.

In one aspect, method 1900, or any aspect related to it, may be performed by an apparatus, such as communications device 2000 of FIG. 20, which includes various components operable, configured, or adapted to perform the method 1900. Communications device 2000 is described below in further detail.

Note that FIG. 19 is just one example of a method, and other methods including fewer, additional, or alternative steps are possible consistent with this disclosure.

### Example Communications Device(s)

FIG. 20 depicts aspects of an example communications device 2000. In some aspects, communications device 2000 is a user equipment, such as UE 104 described above with respect to FIGS. 1 and 3. In some aspects, communications device 2000 is a network entity, such as BS 102 of FIGS. 1 and 3, or a disaggregated base station as discussed with respect to FIG. 2.

The communications device 2000 includes a processing system 2002 coupled to the transceiver 2058 (e.g., a transmitter and/or a receiver). In some aspects (e.g., when communications device 2000 is a network entity), processing system 2002 may be coupled to a network interface 2062 that is configured to obtain and send signals for the communications device 2000 via communication link(s), such as a backhaul link, midhaul link, and/or fronthaul link as described herein, such as with respect to FIG. 2. The transceiver 2058 is configured to transmit and receive signals for the communications device 2000 via the antenna 2060, such as the various signals as described herein. The processing system 2002 may be configured to perform processing functions for the communications device 2000, including processing signals received and/or to be transmitted by the communications device 2000.

The processing system 2002 includes one or more processors 2004. In various aspects, the one or more processors 2004 may be representative of one or more of receive processor 358, transmit processor 364, TX MIMO processor 366, and/or controller/processor 380, as described with respect to FIG. 3. In various aspects, one or more processors 2004 may be representative of one or more of receive processor 338, transmit processor 320, TX MIMO processor 330, and/or controller/processor 340, as described with respect to FIG. 3. The one or more processors 2004 are coupled to a computer-readable medium/memory 2030 via a bus 2056. In certain aspects, the computer-readable medium/memory 2030 is configured to store instructions (e.g., computer-executable code) that when executed by the one or more processors 2004, cause the one or more processors 2004 to perform the method 1700 described with respect to FIG. 17, or any aspect related to it; the method 1800 described with respect to FIG. 18, or any aspect related to it; and the method 1900 described with respect to FIG. 19, or any aspect related to it. Note that reference to a processor performing a function of communications device 2000 may include one or more processors 2004 performing that function of communications device 2000.

In the depicted example, computer-readable medium/memory 2030 stores code (e.g., executable instructions), such as code for transmitting 2032, code for communicating 2034, code for obtaining 2036, code for determining 2038, code for configuring 2040, code for switching 2042, code for receiving 2044, code for varying 2046, code for updating 2048, code for participating 2050, code for adjusting 2052, and code for processing 2054. Processing of the code for transmitting 2032, code for communicating 2034, code for obtaining 2036, code for determining 2038, code for configuring 2040, code for switching 2042, code for receiving 2044, code for varying 2046, code for updating 2048, code for participating 2050, code for adjusting 2052, and code for processing 2054 may cause the communications device 2000 to perform the method 1700 described with respect to FIG. 17, or any aspect related to it; the method 1800 described with respect to FIG. 18, or any aspect related to it; and the method 1900 described with respect to FIG. 19, or any aspect related to it.

The one or more processors 2004 include circuitry configured to implement (e.g., execute) the code stored in the computer-readable medium/memory 2030, including circuitry for transmitting 2006, circuitry for communicating 2008, circuitry for obtaining 2010, circuitry for determining 2012, circuitry for configuring 2014, circuitry for switching 2016, circuitry for receiving 2018, circuitry for varying 2020, circuitry for updating 2022, circuitry for participating 2024, circuitry for adjusting 2026, and circuitry for processing 2028. Processing with circuitry for transmitting 2006, circuitry for communicating 2008, circuitry for obtaining 2010, circuitry for determining 2012, circuitry for configuring 2014, circuitry for switching 2016, circuitry for receiving 2018, circuitry for varying 2020, circuitry for updating 2022, circuitry for participating 2024, circuitry for adjusting 2026, and circuitry for processing 2028 may cause the communications device 2000 to perform the method 1700 described with respect to FIG. 17, or any aspect related to it; the method 1800 described with respect to FIG. 18, or any aspect related to it; and the method 1900 described with respect to FIG. 19, or any aspect related to it.

Various components of the communications device 2000 may provide means for performing the method 1700 described with respect to FIG. 17, or any aspect related to it; the method 1800 described with respect to FIG. 18, or any aspect related to it; and the method 1900 described with respect to FIG. 19, or any aspect related to it. For example, means for transmitting, sending or outputting for transmission may include transceivers 354 and/or antenna(s) 352 of the UE 104 illustrated in FIG. 3, transceivers 332 and/or antenna(s) 334 of the BS 102 illustrated in FIG. 3, and/or the transceiver 2058 and the antenna 2060 of the communications device 2000 in FIG. 20. Means for receiving or obtaining may include transceivers 354 and/or antenna(s) 352 of the UE 104 illustrated in FIG. 3, transceivers 332 and/or antenna(s) 334 of the BS 102 illustrated in FIG. 3, and/or the transceiver 2058 and the antenna 2060 of the communications device 2000 in FIG. 20.

### Example Clauses

Implementation examples are described in the following numbered clauses:
Clause 1: A method for wireless communications at a network entity, comprising: transmitting signaling configuring at least one reconfigurable intelligent surface (RIS) with a time-domain rotation factor to apply time variant reflection coefficient rotation, wherein the time-domain rotation factor is based on a Doppler frequency corresponding to a reflection link between the network entity and a user equipment (UE) via the at least one RIS; and communicating with the UE, via the RIS, after transmitting the signaling.
Clause 2: The method of Clause 1, further comprising: obtaining information regarding the Doppler frequency corresponding to the reflection link; and determining the time-domain rotation factor, based at least on the Doppler frequency corresponding to the reflection link.
Clause 3: The method of Clause 2, wherein determination of the time-domain rotation factor depends on at least one of: whether a direct link exists between the network entity and the UE or whether the network entity compensates for Doppler frequency corresponding to the direct link.
Clause 4: The method of Clause 2, wherein obtaining information regarding the Doppler frequency comprises: receiving a measurement report from the UE indicating the Doppler frequency.
Clause 5: The method of Clause 4, further comprising configuring the at least one RIS to use a basic reflection coefficient without rotation in at least a portion of some symbols to allow the UE to measure the Doppler frequency.
Clause 6: The method of Clause 2, wherein obtaining information regarding the Doppler frequency comprises: determining the Doppler frequency based on measurements of an uplink reference signal from the UE.
Clause 7: The method of Clause 2, further comprising switching off the at least one RIS to determine a Doppler frequency corresponding to at least one of: a direct link between the network entity and the UE, or a reflective link between the network entity and the UE, via at least one other RIS.
Clause 8: The method of any one of Clauses 1-7, further comprising: determining a time-domain rotation period that determines how often coefficients of RIS elements of the at least one RIS are updated based on the time-domain rotation factor.
Clause 9: The method of Clause 8, further comprising: receiving signaling indicating a capability of the at least one RIS regarding RIS element coefficient change response time, wherein the time-domain rotation period is determined based on the capability.
Clause 10: The method of Clause 8, further comprising transmitting an indication of the time-domain rotation period to at least one of: the UE or the at least one RIS.
Clause 11: The method of any one of Clauses 1-10, further comprising: determining a time gap for the at least one RIS to change RIS element coefficients based on the time-domain rotation factor.
Clause 12: The method of Clause 11, further comprising transmitting an indication of the time gap to at least one of: the UE or the at least one RIS.
Clause 13: A method for wireless communications at a reconfigurable intelligent surface (RIS) controller, comprising: receiving signaling, from a network entity, indicating a time-domain rotation factor; and varying reflection coefficients of one or more elements of at least one RIS by applying a time variant reflection coefficient rotation, based on the time-domain rotation factor.
Clause 14: The method of Clause 13, further comprising receiving signaling, from the network entity, to configure the at least one RIS to use a basic reflection coefficient without rotation in at least a portion of some symbols.
Clause 15: The method of any one of Clauses 13-14, further comprising: determining a time-domain rotation period that determines how often coefficients of RIS elements of the at least one RIS are updated based on the time-domain rotation factor.
Clause 16: The method of Clause 15, further comprising: transmitting signaling, to the network entity, indicating a capability of the at least one RIS regarding RIS element coefficient change response time, wherein the time-domain rotation period is determined based on the capability.
Clause 17: The method of Clause 15, further comprising receiving an indication of the time-domain rotation period from the network entity.
Clause 18: The method of any one of Clauses 13-17, further comprising: determining a time gap for changing RIS element coefficients based on the time-domain rotation factor.
Clause 19: The method of Clause 18, further comprising receiving an indication of the time gap from the network entity.
Clause 20: A method for wireless communications at a user equipment (UE), comprising: receiving, from a network entity, signaling indicating a time-domain rotation period that determines how often coefficients of reconfigurable intelligent surface (RIS) elements of at least one RIS are updated; and updating Doppler processing performed at the UE, based on the time-domain rotation period.
Clause 21: The method of Clause 20, further comprising participating in a procedure to measure a Doppler frequency corresponding to a reflection link between the network entity and the UE, via the at least one RIS.
Clause 22: The method of Clause 21, wherein participating in the procedure to measure the Doppler frequency corresponding to the reflection link comprises: measuring downlink reference signals reflected from the at least one RIS; determining the Doppler frequency corresponding to the reflection link, based on the measuring; and transmitting a measurement report indicating the Doppler frequency corresponding to the reflection link.
Clause 23: The method of Clause 21, wherein participating in the procedure to measure the Doppler frequency corresponding to the reflection link comprises: transmitting an uplink reference signal from the UE.
Clause 24: The method of any one of Clauses 20-23, further comprising: receiving, from the network entity, signaling indicating a time gap for the at least one RIS to change RIS element coefficients.
Clause 25: The method of Clause 24, further comprising adjusting at least one of rate matching or channel measurement, based on the time gap.
Clause 26: The method of any one of Clauses 20-25, further comprising: receiving data signals from at least a reflection link between the network entity and the UE, via the at least one RIS; and processing the data signals in a manner depending on whether the data signal are received with zero or at least one Doppler frequency.
Clause 27: The method of Clause 26, wherein the processing comprises: taking action to compensate for a Doppler frequency offset if the data signals are received with at least one Doppler frequency.
Clause 28: An apparatus, comprising: a memory comprising executable instructions; and a processor configured to execute the executable instructions and cause the apparatus to perform a method in accordance with any one of Clauses 1-27.
Clause 29: An apparatus, comprising means for performing a method in accordance with any one of Clauses 1-27.
Clause 30: A non-transitory computer-readable medium comprising executable instructions that, when executed by a processor of an apparatus, cause the apparatus to perform a method in accordance with any one of Clauses 1-27.
Clause 31: A computer program product embodied on a computer-readable storage medium comprising code for performing a method in accordance with any one of Clauses 1-27.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112 (f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. An apparatus for wireless communications at a network entity, comprising:
a processor;
memory coupled with the processor; and
instructions stored in the memory and executable by the processor to cause the apparatus to:
transmit signaling configuring at least one reconfigurable intelligent surface (RIS) with a time-domain rotation factor to apply time variant reflection coefficient rotation, wherein the time-domain rotation factor is based on a Doppler frequency corresponding to a reflection link between the network entity and a user equipment (UE) via the at least one RIS; and
communicate with the UE, via the at least one RIS, after transmitting the signaling.

2. The apparatus of claim 1, wherein the instructions are further executable by the processor to cause the apparatus to:
obtain information regarding the Doppler frequency corresponding to the reflection link; and
determine the time-domain rotation factor, based at least on the Doppler frequency corresponding to the reflection link.

3. The apparatus of claim 2, wherein determination of the time-domain rotation factor depends on at least one of: whether a direct link exists between the network entity and the UE or whether the network entity compensates for Doppler frequency corresponding to the direct link.

4. The apparatus of claim 2, wherein obtaining information regarding the Doppler frequency comprises:
receiving a measurement report from the UE indicating the Doppler frequency.

5. The apparatus of claim 4, wherein the instructions are further executable by the processor to cause the apparatus to configure the at least one RIS to use a basic reflection coefficient without rotation in at least a portion of some symbols to allow the UE to measure the Doppler frequency.

6. The apparatus of claim 2, wherein obtaining information regarding the Doppler frequency comprises:
determining the Doppler frequency based on measurements of an uplink reference signal from the UE.

7. The apparatus of claim 2, wherein the instructions are further executable by the processor to cause the apparatus to:
switch off the at least one RIS to determine a Doppler frequency corresponding to at least one of:
a direct link between the network entity and the UE; or
a reflective link between the network entity and the UE, via at least one other RIS.

8. The apparatus of claim 1, wherein the instructions are further executable by the processor to cause the apparatus to determine a time-domain rotation period that determines how often coefficients of RIS elements of the at least one RIS are updated based on the time-domain rotation factor.

9. The apparatus of claim 8, wherein the instructions are further executable by the processor to cause the apparatus to receive signaling indicating a capability of the at least one RIS regarding RIS element coefficient change response time, wherein the time-domain rotation period is determined based on the capability.

10. The apparatus of claim 8, wherein the instructions are further executable by the processor to cause the apparatus to transmit an indication of the time-domain rotation period to at least one of: the UE or the at least one RIS.

11. The apparatus of claim 1, wherein the instructions are further executable by the processor to cause the apparatus to:
determine a time gap for the at least one RIS to change RIS element coefficients based on the time-domain rotation factor.

12-19. (canceled)

20. An apparatus for wireless communications at a user equipment (UE), comprising:
a processor;
memory coupled with the processor; and
instructions stored in the memory and executable by the processor to cause the apparatus to:
receive, from a network entity, signaling indicating a time-domain rotation period that determines how often coefficients of reconfigurable intelligent surface (RIS) elements of at least one RIS are updated; and
update Doppler processing performed at the UE, based on the time-domain rotation period.

21. The apparatus of claim 20, wherein the instructions are further executable by the processor to cause the apparatus to participate in a procedure to measure a Doppler frequency corresponding to a reflection link between the network entity and the UE, via the at least one RIS.

22. The apparatus of claim 21, wherein participating in the procedure to measure the Doppler frequency corresponding to the reflection link comprises:
measuring downlink reference signals reflected from the at least one RIS;
determining the Doppler frequency corresponding to the reflection link, based on the measuring; and
transmitting a measurement report indicating the Doppler frequency corresponding to the reflection link.

23. The apparatus of claim 21, wherein participating in the procedure to measure the Doppler frequency corresponding to the reflection link comprises:
transmitting an uplink reference signal from the UE.

24. The apparatus of claim 20, wherein the instructions are further executable by the processor to cause the apparatus to:
receive, from the network entity, signaling indicating a time gap for the at least one RIS to change RIS element coefficients.

25. The apparatus of claim 24, wherein the instructions are further executable by the processor to cause the apparatus to adjust at least one of rate matching or channel measurement, based on the time gap.

26. The apparatus of claim 20, wherein the instructions are further executable by the processor to cause the apparatus to:
receive data signals from at least a reflection link between the network entity and the UE, via the at least one RIS; and
process the data signals in a manner depending on whether the data signal are received with zero or at least one Doppler frequency.

27. The apparatus of claim 26, wherein the processing comprises:
taking action to compensate for a Doppler frequency offset if the data signals are received with at least one Doppler frequency.

28. A method for wireless communications at a user equipment (UE), comprising:
receiving, from a network entity, signaling indicating a time-domain rotation period that determines how often coefficients of reconfigurable intelligent surface (RIS) elements of at least one RIS are updated; and
updating Doppler processing performed at the UE, based on the time-domain rotation period.
